(19) United States
(12) Patent Application Publication
(10) Pub. No.: US 2013/0098502 A1
(43) Pub. Date: Apr. 25, 2013

(54) EDGE-BAND CHAMFERING DEVICE

(71) Applicant: Chin-Chi Lin, Taichung City (TW)

(72) Inventor: Chin-Chi Lin, Taichung City (TW)

(21) Appl. No.: 13/277,564

(22) Filed: Oct. 20, 2011

(51) Int. Cl. B27C 5/10

(52) U.S. Cl. 144/154.5

(57) ABSTRACT

An edge-band chamfering device includes a driving unit, a supporting frame unit, and a chamfering unit. The driving unit includes a main housing, a motor disposed within the main housing, and a spindle driven by the motor. The main housing includes an annular wall having an externally threaded portion. The supporting frame unit includes a fixed seat and a sleeve. The fixed seat has a sleeving portion formed with a through hole therethrough, and a fixed portion connected to a side of the sleeving portion. The sleeve has a surrounding wall disposed within the through hole. The surrounding wall has an internally threaded portion engaging the externally threaded portion. The chamfering unit includes a cutter mounted to the spindle.

### BACKGROUND OF THE INVENTION

1. Field of the Invention

This invention relates to a chamfering device, and more particularly to an edge-band chamfering device.

2. Description of the Related Art

Referring to FIGS. 1 and 2, a conventional edge-band chamfering device 1 includes a fixed frame unit 11, a driving unit 12 extending through the fixed frame unit 11, and an adjusting member 13 disposed between the fixed frame unit 11 and the driving unit 12. The fixed frame unit 11 has a sleeving portion 111 sleeved on the driving unit 12 and formed with a deformable slit 112 at a side thereof, a locking member 113 extending through the deformable slit 112 to allow the driving unit 12 to be clamped within the sleeving portion 111 and a fixed portion 114 extending laterally from the sleeving portion 111. The driving unit 12 has a grip portion 121 located above the sleeving portion 111, a connecting portion 122 extending downwardly into the sleeving portion 111, and a cutter portion 123 extending downwardly and outwardly from the fixed frame unit 11. The adjusting member 13 has a threaded rod portion 131 engaging threadably the sleeving portion 111, an abutting portion 132 disposed, under and abutting against the grip portion 121, and a dial disc portion 133 disposed between the threaded rod portion 131 and the abutting portion 132.

With further reference to FIG. 3, the conventional edge-band chamfering device 1 is used to chamfer an edge band 101 of a plank 100. During use, the adjusting member 13 is first operated to adjust the cutter portion 123 to an appropriate height. Next, the fixed portion 114 is placed on the plank 100 in such a manner to allow the cutter portion 123 to abut against the edge band 101 for subsequent chamfering operation.

However, the diameter of the threaded rod portion 131 is too large and the area of the dial disc portion 133 is too small to perform a precise small-angle rotation thereof. If the position of the cutter portion 123 is too high, a sharp edge 102 will be formed at a top end of the edge band 101. It the position of the cutter portion 123 is too low, damage may be caused to a surface 103 of the plank 100.

### SUMMARY OF THE INVENTION

The object of this invention is to provide an edge-band chamfering device that can adjust precisely the height of a cutter.

According to this invention, an edge-band chamfering device includes a driving unit, a supporting frame unit, and a chamfering unit. The driving unit includes a main housing, a motor disposed within the main housing, and a spindle driven by the motor. The main housing includes an annular wall having an externally threaded portion. The supporting frame unit includes a fixed seat and a sleeve. The fixed seat has a sleeving portion formed with a through hole therethrough, and a fixed portion connected to a side of the sleeving portion. The sleeve has a surrounding wall disposed within the through hole. The surrounding wall has an internally threaded portion engaging the externally threaded portion. The chamfering unit includes a cutter mounted to the spindle.

Since the diameter of each of the externally threaded portion of the annular wall and the internally threaded portion of the surrounding wall can be comparatively large, the height of the cutter relative to the sleeving portion can be adjusted precisely.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 a front view of a conventional edge-band chamfering device;

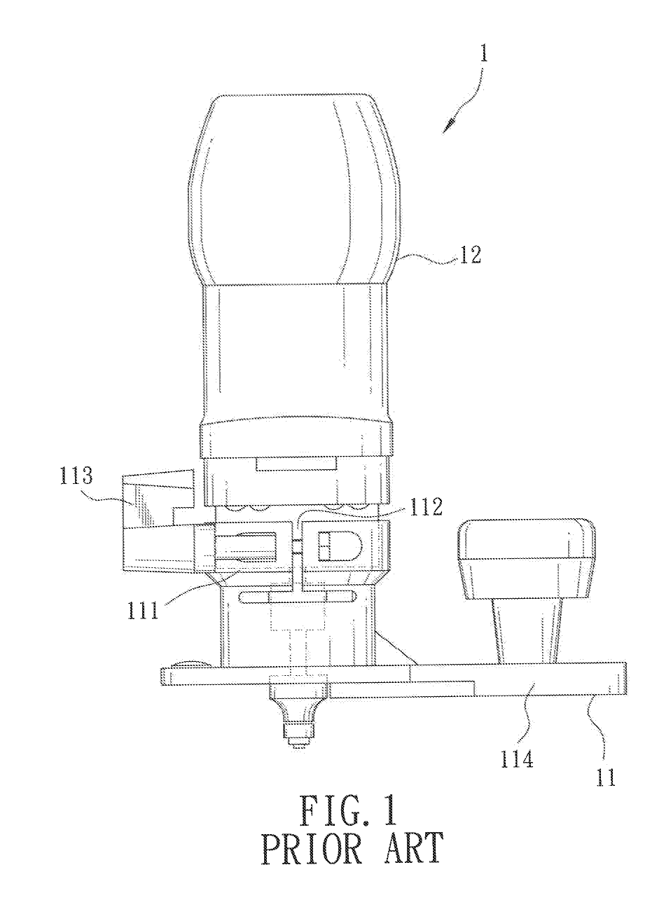

FIG. 2 is a rear view of the conventional edge-band chamfering device;

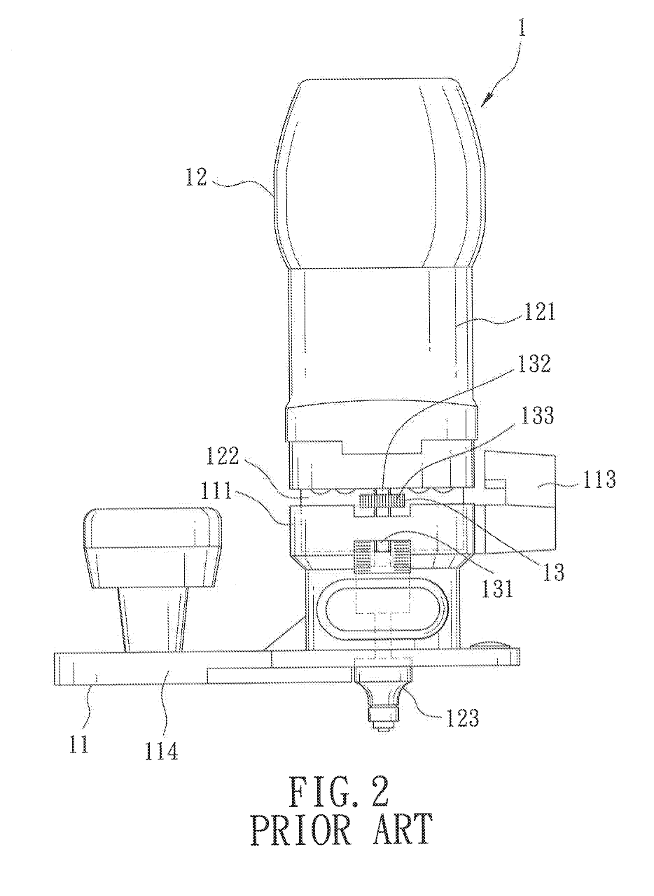

FIG. 3 is a schematic view illustrating use of the conventional edge-band chamfering device;

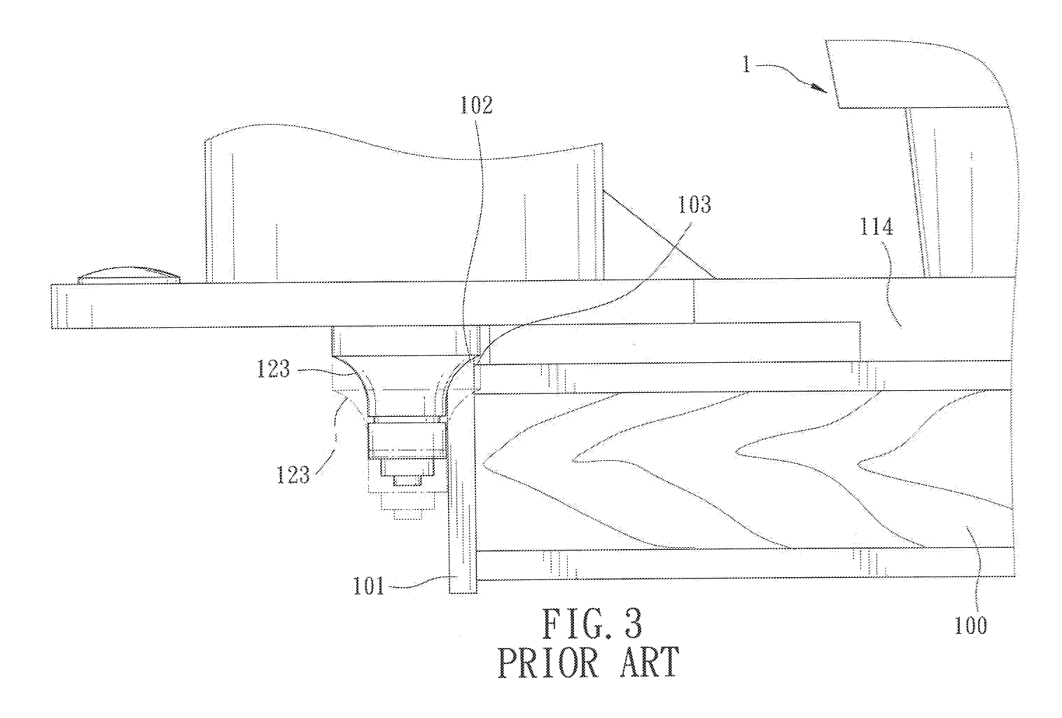

FIG. 4 is an assembled perspective view of the preferred embodiment of an edge-band chamfering device according to this invention;

FIG. 5 is a partly exploded top perspective view of the preferred embodiment;

FIG. 6 is a partly exploded bottom perspective view of the preferred embodiment;

FIG. 7 is a partly exploded perspective view of a driving unit and a sleeve of the preferred embodiment;

FIG. 8 is a fragmentary perspective view of the preferred embodiment, illustrating a height scale and a graduation ring;

FIG. 9 is a schematic sectional view of the preferred embodiment, illustrating an operating position and an idle position of a positioning rod;

FIG. 10 is a schematic top view illustrating use of the preferred embodiment; and

FIG. 11 is a view similar to FIG. 10 but illustrating use of a positioning rod.

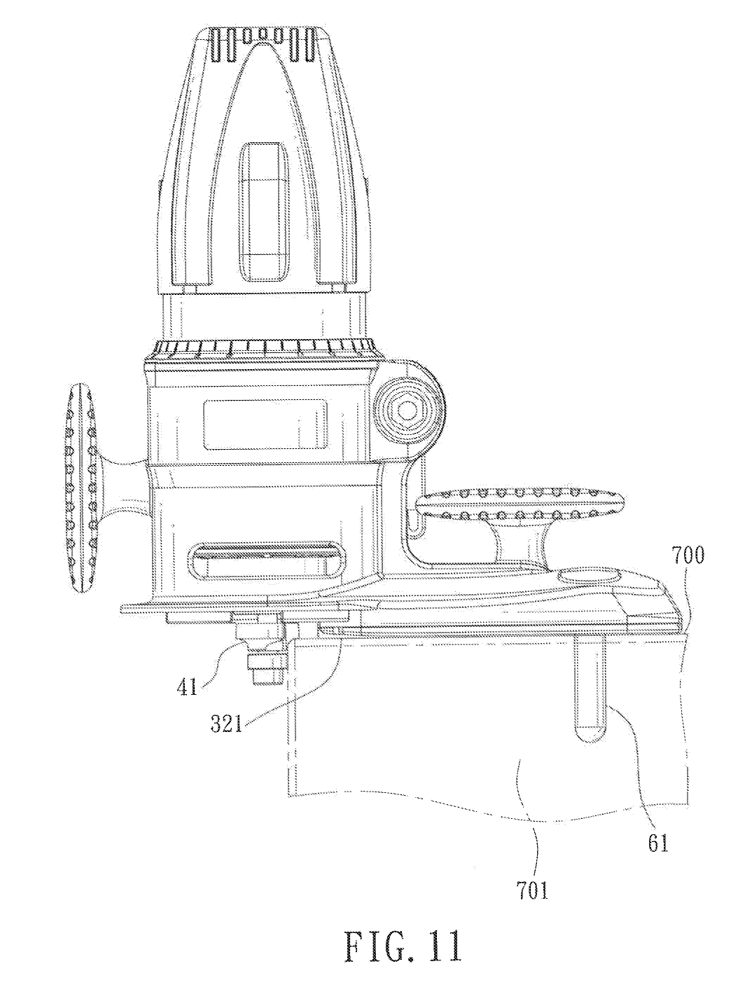

### DETAILED DESCRIPTION OF THE PREFERRED EMBODIMENT

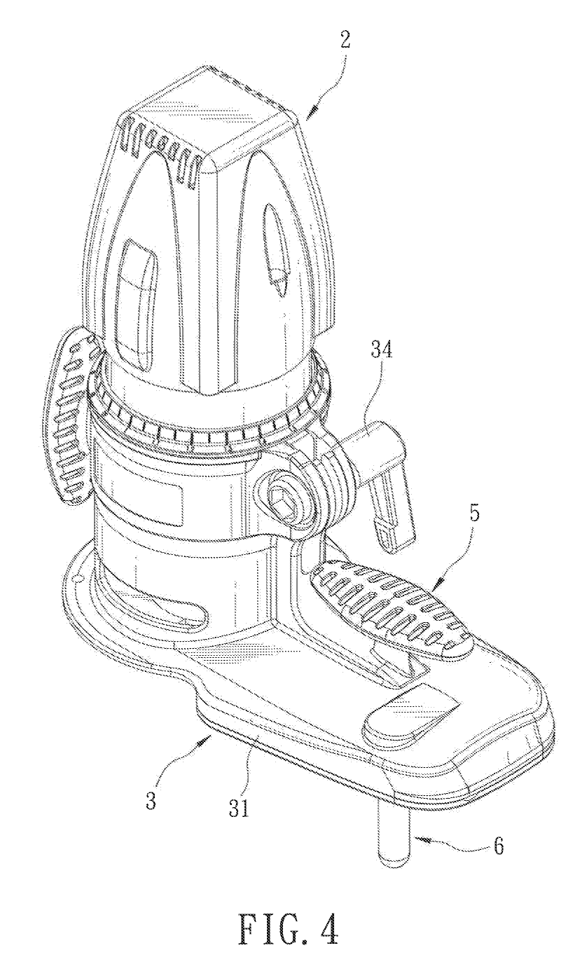

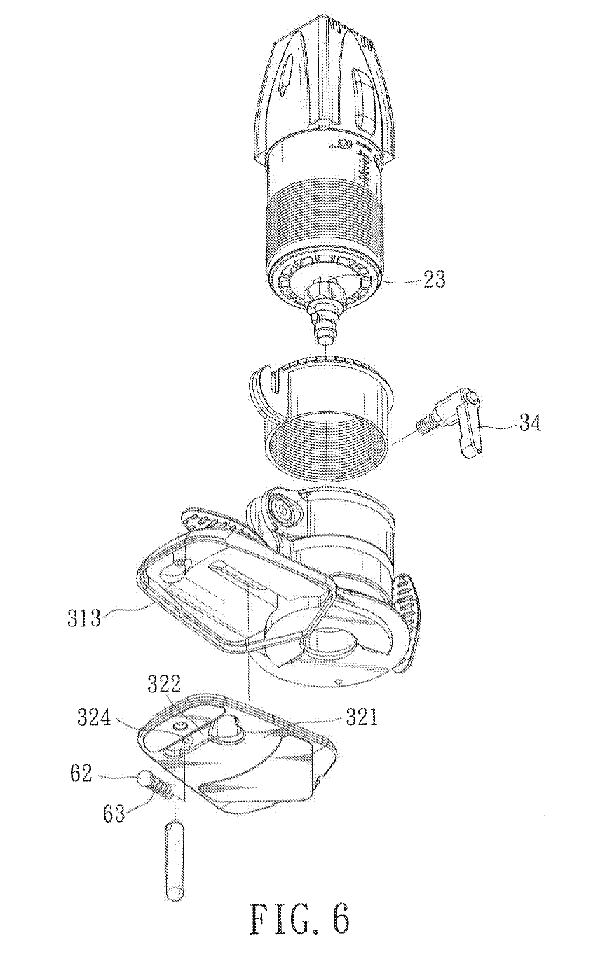

Referring to FIGS. 4, 5, and 6, the preferred embodiment of an edge-band chamfering device according to this invention includes a driving unit 2, a supporting frame unit 3, a chamfering unit 4, a handle unit 5, and a positioning unit 6.

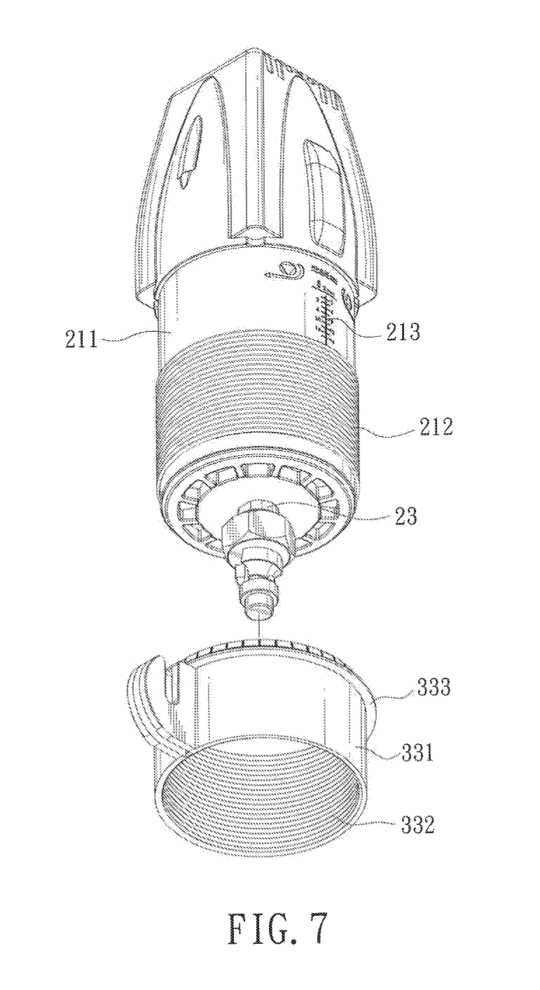

With additional reference to FIG. 7, the driving unit 2 includes a main housing 21, a motor 22 disposed within the main housing 21, and a spindle 23 driven by the motor 22.

The main housing 21 including an annular wall 211 having an externally threaded portion 212, and a height scale 213 disposed on the annular wall 211. In this embodiment, the pitch of the externally threaded portion 212 is 2 mm. The height scale 213 is disposed above the externally threaded portion 212, and has a plurality of parallel height-representing lines arranged along a longitudinal direction of the spindle 23.

The supporting frame unit 3 includes a fixed seat 31, a sleeve 33, and a locking member 34 connected adjustably to the fixed seat 31.

The fixed seat 31 has a sleeving portion 311 formed with a through hole 312 therethrough, and a fixed portion 313 connected fixedly to a side of the sleeving portion 311. In this embodiment, a bottom end of fixed portion 313 is below that of the sleeving portion 311.

The sleeving portion 311 has a clamping wall 314 abutting against the sleeve 33, and a pair of first and second extension walls 316 extending outwardly from the clamping wall 314 to define a deformable slit 317. In this embodiment, the cross-section of the clamping wall 314 is C-shape, and has two adjacent ends, and the first and second extension walls 315, 316 extend respectively from the ends of the clamping wall 314.

The fixed portion 313 has a horizontal abutment face 321, an accommodating groove 322 formed in the abutment face 321, a hollow projecting block 323, and a slide slot 324 formed in the projecting block 323 and in spatial communication with the accommodating groove 322.

The sleeve 33 is made of a deformable material, such as a plastic material, and has a surrounding wall 331 disposed within the through hole 312 and having an internally threaded portion 332 engaging the externally threaded portion 212, a graduation ring 333 connected fixedly to the surrounding wall 331, abutting against the clamping wall 314, and aligned with the height scale 213, and an anchoring projection 334 extending outwardly from the surrounding wall 331 and disposed within the deformable slit 317. The anchoring projection 334 is formed with an upwardly opening groove 335.

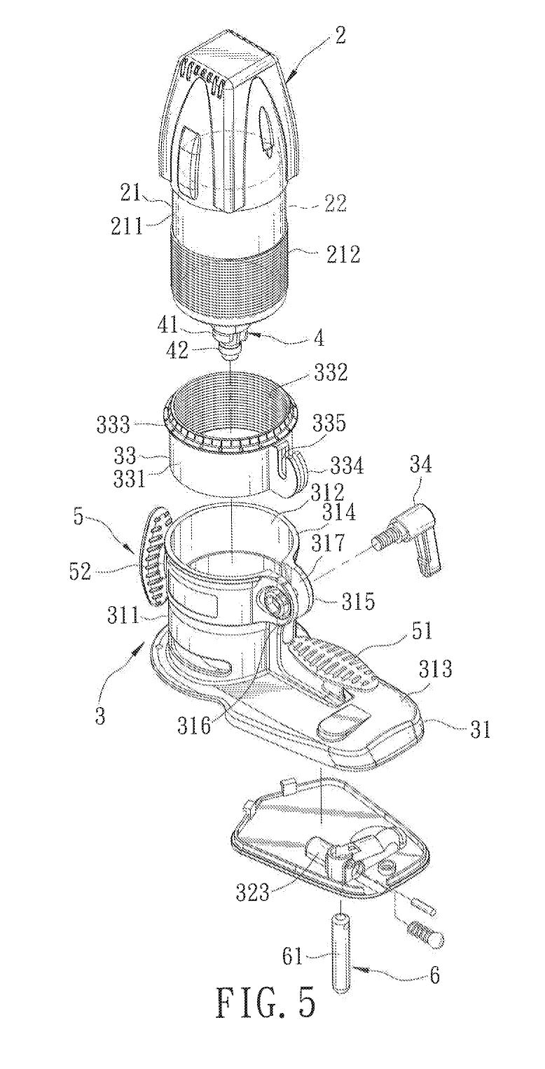

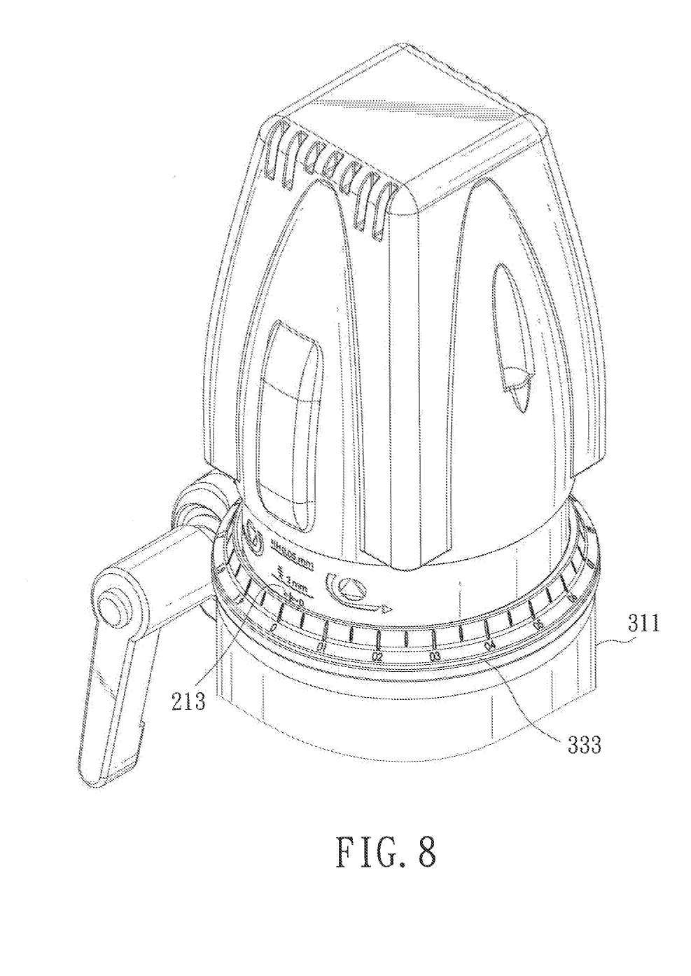

With particular reference to FIGS. 5, 7, and 8, in this embodiment, the surrounding wall 331 is surrounded by the clamping wall 314. Each of the internally threaded portion 332 and the externally threaded portion 212 is 2 mm. The graduation ring 333 includes 40 graduation lines, by which the graduation ring 333 are divided into 40 sections. As such, each of the sections corresponds to a cutter-feeding amount of 2 mm/40=0.05 mm.

With particular reference to FIGS. 5, 6, and 8, the locking member 34 is connected adjustably to the first and second extension walls 315, 316, and extends through the deformable slit 317 and the groove 335 in the anchoring projection 334. The locking member 34 is operable to adjust the clamping force of the clamping wall 314 to the surrounding wall 331.

The chamfering unit 4 includes a cutter 41 mounted to the spindle 23, and a bearing 42 disposed under and connected to the cutter 41 in a known manner.

The handle unit 5 includes a first handle 51 disposed on the fixed portion 313, and a second handle 52 disposed on the sleeving portion 311. The first handle 51 extends upwardly from a fop surface of the fixed portion 313. The second handle 52 extends from an outer peripheral surface of the sleeving portion 311.

The positioning unit 6 includes a positioning rod 61 disposed pivotally on the fixed portion 313, a pushing member 62 disposed movably within the slide slot 324, and a resilient member 63 disposed within the slide slot 324 for biasing the pushing member 62 to press against the positioning rod 62. In this embodiment, the positioning rod 61 has a circular cross-section, and the pushing member 63 is configured as a ball.

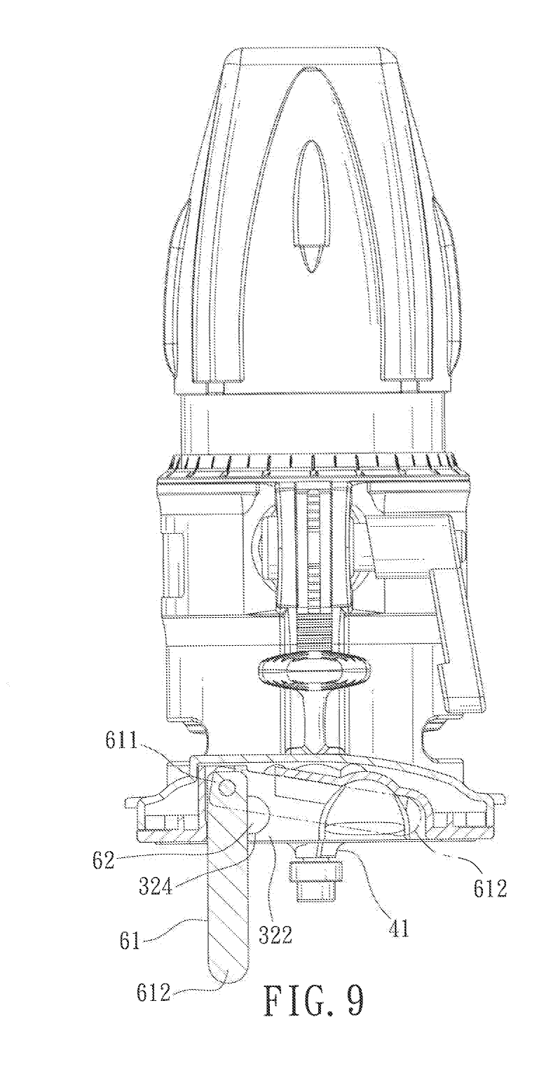

With particular reference to Figs. 5, 6, and 9, the positioning rod 61 is pivot able relative to the fixed portion 313 between an idle position (shown by the phantom lines in FIG. 9) whereat the positioning rod 61 does not project outwardly from the abutment face 321, and an operating position (shown by the solid lines in FIG. 9) whereat the positioning rod 61 projects outwardly from the abutment face 321 and is parallel to the spindle 23. The positioning rod 61 can be maintained at either the operating position or the idle position by the biasing force of the resilient member 63, and has a pivot end 611 connected pivotably to the fixed portion 313, and a free end 612 opposite to the pivot end 611.

When the positioning rod 61 is at the idle position, the free end 612 is disposed in the accommodating groove 322. When the positioning rod 61 is at the operating position, the free end 612 is disposed outwardly of the accommodating groove 322.

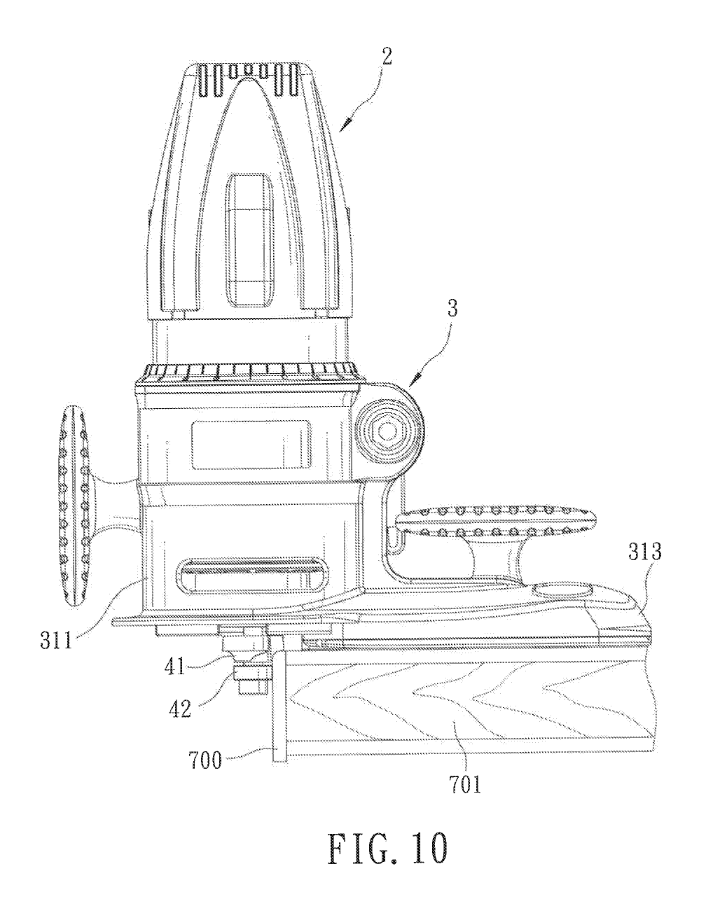

Referring to FIGS. 5, 6, and 10, when it is desired to chamfer an edge band 700 adhered to a plank 701 (such as a table top) using the edge-band chamfering device, the locking member 34 is first loosened to release the sleeve 33 from the clamping wall 314 to thereby allow for rotation of the driving unit 2 relative to the supporting frame unit 3. Hence, the cutter 41 can be adjusted to an appropriate height. Next, the locking member 34 is tightened to deform the sleeve 33 to thereby clamp the sleeve 33 and the annular wall 211 within the clamping wall 314 for preventing rotation of the driving unit 2 relative to the supporting frame unit 3. Afterwards, the fixed portion 313 is placed on the plank 701, and the bearing 42 is moved into contact with the edge band 700, so that the cutter 41 can be driven to chamfer the edge band 700.

In view of the above, since the externally threaded portion 212 and the internally threaded portion 332 are disposed respectively at the annular wall 211 and the surrounding wall 331, the minimum adjustable angle during relative rotation of the driving unit 2 relative to the supporting frame unit 3 is much smaller than that of the above-mentioned prior art, thereby resulting in a more precise adjustment to the height of the cutter 41 relative to the sleeving portion 311. Thus, the object of this invention is achieved. Furthermore, due to the arrangement of the first and second handles 51, 52, a force can be applied conveniently by the user to the edge-band chamfering device without risk of scald accidents caused by heat generated from the motor 22. Further, if necessary, the positioning rod 61 can be pivoted to the operating position and brought into contact with a top surface of the plank 701 to assist the abutment face 321 in intimate contact with a side surface of the plank 701 during the chamfering operation.

With this invention thus explained, it is apparent that numerous modifications and variations can be made without departing from the scope and spirit of this invention. It is therefore intended that this invention be limited only as indicated by the appended claims.

I claim;

1. An edge-band chamfering device comprising:
a driving unit including a main housing, a motor disposed within said main housing, and a spindle driven by said motor, said main housing including an annular wall having an externally threaded portion;
a supporting frame unit including a fixed seat and a sleeve, said fixed seat having a sleeving portion formed with a through hole therethrough, and a fixed portion connected to a side of said sleeving portion, said sleeve having a surrounding wall disposed within said through hole, said surrounding wall having an internally threaded portion engaging said externally threaded portion; and
a chamfering unit including a cutter mounted to said spindle.

2. The edge-band chamfering device as claimed in claim 1, wherein said main housing further has a height scale disposed on said annular wall, and said further sleeve further has a graduation ring connected fixedly to said surrounding wall and aligned with said height scale.

3. The edge-band chamfering device as claimed in claim 2, wherein:
said sleeving portion has a clamping wall abutting against said graduation ring and having two adjacent ends, and a pair of first and second extension walls extending respectively and outwardly from said ends of said clamping wall to define a deformable slit therebetween;
said sleeve further has an anchoring projection extending outwardly from said surrounding wall and disposed within said deformable slit, said anchoring projection being formed with an upwardly opening groove; and
said supporting frame unit further includes a locking member connected adjustably to said first and second extension walls and extending through said deformable slit and said groove in said anchoring projection.

4. The edge-band chamfering device as claimed in claim 3, wherein said sleeve is made of a deformable material, and said locking member is operable to deform said sleeve so as to prevent relative rotation between said externally threaded portion and said internally threaded portion.

5. The edge-band chamfering device as claimed in claim 1, further comprising a handle unit that includes a first handle disposed on said fixed portion, and a second handle disposed on said sleeving portion.

6. The edge-band chamfering device as claimed in claim 5, wherein said fixed portion has a top surface, said first handle extending upwardly from said top surface, said sleeving portion having an outer peripheral surface, said second handle extending from said outer peripheral surface of said sleeving portion.

7. The edge-band chamfering device as claimed in claim 1, further comprising a positioning unit, said fixed portion has a horizontal abutment face, said positioning unit including a positioning rod disposed pivotally on said fixed portion and pivotable relative to said fixed portion between an operating portion whereat said positioning rod projects outwardly from said abutment face and is parallel to said spindle, and an idle position whereat said positioning rod does not project outwardly from said abutment face.

8. The edge-band chamfering device as claimed in claim 7, wherein said fixed portion further has an accommodating groove formed in said abutment face, said positioning rod having a pivot end connected pivotally to said fixed portion, and a free end that is disposed outwardly of said accommodating groove when said positioning rod is at the operating position and that is disposed in said accommodating groove when said positioning rod is at the idle position.

9. The edge-band chamfering device as claimed in claim 8, wherein said fixed portion further has a slide slot in spatial communication with said accommodating groove, said positioning unit further includes a pushing member disposed movably within said slide slot, and a resilient member disposed within said slide slot for biasing said pushing member to press against said positioning rod so as to maintain said positioning rod at the operating position and the idle position.
